(19) United States
(12) Patent Application Publication
(10) Pub. No.: US 2021/0344208 A1
(43) Pub. Date: Nov. 4, 2021

(54) EV Charging System for Micromobility Vehicles Having a Battery Management System with Control and Discharge Electronics

(71) Applicant: ZapBatt, Inc., Hermosa Beach, CA (US)

(72) Inventors: Charles Welch, Hermosa Beach, CA (US); David Felzer, Oceanside, CA (US)

(73) Assignee: ZapBatt, Inc., Hermosa Beach, CA (US)

(21) Appl. No.: 17/301,952

(22) Filed: Apr. 20, 2021

Related U.S. Application Data
(63) Continuation-in-part of application No. 17/301,398, filed on Apr. 1, 2021.
(60) Provisional application No. 63/013,280, filed on Apr. 21, 2020.

(51) Int. Cl. H02J 7/00; B60L 58/22; B60L 53/60

(52) U.S. Cl. CPC H02J 7/0049; H02J 7/0016; H02J 3/32; B60L 53/60; B60L 58/22

(57) ABSTRACT

A micromobility vehicle charging system for charging a lithium titanate battery pack is provided. The system is configured to be interposed between a vehicle battery pack and an electrical connector for electric vehicles. The system includes a charging unit configured to charge a battery pack having a plurality of rechargeable cells, the charging unit configured to monitor the charging state and status of each cell during both charging and discharging. A balancing unit electrically coupled to the charging unit is configured to balance voltage across each rechargeable cell of the plurality of rechargeable cells.

### CROSS REFERENCE TO RELATED APPLICATION

The present application is a continuation-in-part and claims the benefit of U.S. Utility patent application Ser. No. 17/301,398, filed Apr. 1, 2021 (Apr. 1, 2021), which claims the benefit of the filing date of U.S. Provisional Patent Application Ser. No. 63/003,539, filed Apr. 1, 2020 (Apr. 1, 2020), and further claims the benefit of U.S. Provisional Patent Application Ser. No. 63/013,280, filed Apr. 21, 2020 (Apr. 21, 2020), which applications are incorporated in their entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

Field of the Invention: The present invention relates most generally to charging systems for electric vehicles, and more particularly to a device for enabling recharging of micromobility vehicles at conventional electric vehicle charging stations, and still more particularly to a system for connecting a micromobility vehicle having a lithium titanate battery pack to a residential or commercial public electric vehicle charging station having a high power AC input, then converting the power to the required DC voltage and high charging current and controlling the charging process so as to enable rapid and safe charging of the onboard battery system while also having the required safety interlocks and communication protocols that allow the system to be recognized and ultimately enable the electric vehicle charging station to accept the micromobility vehicle.

Background Discussion: Rechargeable batteries are widely used as energy storage devices in a variety of different applications; they have relatively high energy and power density and relatively low cost when compared to other energy storage technologies. Among available rechargeable battery types, the lithium-ion battery is highly favored and widely used in electric and hybrid vehicles due to its high power and energy density. The favored type—lithium-ion—is frequently designed to be repeatedly discharged and re-charged, referred to as a charge cycle, and lithium titanate batteries, which are a type of lithium-ion battery with a lithium-titanate anode rather than graphite anode—are especially well suited for use in micromobility vehicles and light electric vehicles (LEVs) because of the rapidity with which they can be charged.

Advancements in battery technology have stimulated corresponding advancements in battery charging systems and methods. Currently, battery charging systems, sometimes referred to as power supplies, are based on a fixed charging profile in which a constant current is applied to a battery until a predetermined voltage is reached, after which a constant voltage is applied until full capacity is reached. Such charging systems typically provide a limited charging current, due to which the charging system cannot achieve a maximum charging rate, and the total charging time is thereby prolonged.

Lightweight electric micromobility vehicles and LEVs are increasingly popular in urban environments. They provide a fast and convenient mode of transportation for short trips, essentially eliminating parking problems and even introducing a recreational aspect to short range travel, sometimes referred to as last-mile-transit. The term micromobility ranges over such things as e-bikes, electric scooters, electric skateboards, shared bicycles, and pedelec bicycles. The vehicles typically have rapid discharge rates but low charge acceptance rates. For example, the typical micromobility vehicle have motors ranging from 250 W-1000 W, which the battery discharges to meet the power demand; but the same batteries can typically only accept incoming power levels of 70 W-250 W, meaning the charge time will always be considerably longer than the discharge time. This is because onboard circuits do not enable charging at high currents, and managing the differential states of charge of the batteries in a battery pack is critical in preventing overcharge of any of the cells. Low charge acceptance rates and the need for safety result in long recharging times, often overnight or up to ten hours for full charge, depending on battery size. Because of the rapid diffusion of the micromobility technology, especially in e-bike sharing and e-scooter sharing systems along with the growing consumer demand for personal owned micromobility vehicles replacing many consumers “around-town” short car trips with these devices instead, there is an urgent need for a battery charging system that provides rapid charging of rechargeable batteries in micromobility electric vehicles.

### SUMMARY OF THE INVENTION

The present invention provides a charging system configured for rapid charging of micromobility vehicles using either Level 1 or Level 2 EV charging systems. It enables users of micromobility vehicles to employ a public EV charging station or to adapt a home EV charging station for use in recharging a lithium titanate (LTO) battery pack in micromobility vehicles.

The system includes a charging unit configured to charge a battery pack having a plurality of rechargeable cells, the charging unit configured to monitor the charging state and status of each cell during both charging and discharging. A balancing unit electrically coupled to the charging unit is configured to balance voltage across each rechargeable cell of the plurality of rechargeable cells.

The charging system also includes a display unit electrically coupled to the charging unit, and the display unit is configured to display one or more parameters indicating the charge status of the battery pack and any error or fault messages detected from the microcontroller.

In some embodiments, the balancing unit is further configured to balance the voltage across each rechargeable cell of the plurality of rechargeable cells during charging of the battery pack. The balancing may be based on a threshold cell voltage, a threshold battery capacity, and/or a threshold cell voltage variance.

In some embodiments, balancing the voltage across each rechargeable cell of the plurality of rechargeable cells during the charging of the battery pack involves configuring the balancing unit to obtain a current cell voltage, a current battery capacity, and a current cell voltage variance. The balancing unit is configured to determine if the current cell voltage is less than the threshold cell voltage by comparing the current cell voltage and the threshold cell voltage. The balancing unit is further configured to determine if the current battery capacity and the current cell voltage variance are greater than the threshold battery capacity and the threshold cell voltage variance, respectively, by comparing the current battery capacity and the threshold battery capacity, and the current cell voltage variance and the threshold cell voltage variance. The balancing unit is further configured to balance the voltage across each rechargeable cell of the plurality of rechargeable cells, based on a determination that the current cell voltage is less than the threshold cell voltage and a determination that the current battery capacity and the current cell voltage variance are greater than the threshold battery capacity and the threshold cell voltage variance, respectively.

According to some embodiments, the balancing unit is further configured to balance the voltage across each rechargeable cell of the plurality of rechargeable cells by bypassing a charging current through one or more discharge resistors.

According to some embodiments, the balancing unit may be configured to transmit a command to the charging unit to disable charging in the event that at least one rechargeable cell of the plurality of rechargeable cells is charged to full capacity.

In some embodiments, the charging unit may be configured to measure a voltage across the battery pack and a voltage across each rechargeable cell of the plurality of rechargeable cells at regular intervals.

In still other embodiments, the battery pack may be electrically coupled to the balancing unit via a battery terminal connector.

In yet other embodiments, the battery terminal connector includes a plurality of lug connectors.

In some embodiments, rechargeable cells of the plurality of rechargeable cells are connected in series, and a connection is tapped from each rechargeable cells of the plurality of rechargeable cells connected in series, using the plurality of lug connectors, to connect each rechargeable cells of the plurality of rechargeable cells to the balancing unit.

Additionally, in some embodiments, the plurality of cells connected in series are connected by means of printed circuit board (PCB) traces and are electrically coupled to signal trace lines for the purpose of monitoring and balancing of the individual cells.

According to some embodiments, the display unit is electrically coupled to the charging unit via a pigtail cable or via a hardwired lead connector or mounted directly to the PCB as a placed component.

In still further embodiments, the display unit includes an organic light-emitting diode (OLED) display or by other means of graphically displaying information commonly used in consumer electronics.

In embodiments, the one or more parameters indicative of the charge status of the battery pack includes at least one or more showing a battery pack capacity, or a charging current, a discharge current, or a fault notification, or any in combination.

According to some embodiments, the charging system further comprises a heat sink configured to liberate heat energy generated by one or more discharge resistors and other high power electrical components on the charging board.

According to some embodiments, during the charging of the battery pack, discharge of the battery pack across a load is disabled.

According to some embodiments, the discharge of the battery pack across the load is enabled in the event that the charging unit is disconnected.

In accordance with various embodiments, the present disclosure provides a charging system for charging the battery pack. The battery pack may include rechargeable cells (hereinafter “cells”). The charging system includes the charging unit, the balancing unit, and the display unit. An AC to DC power supply of nominal output voltage 24 VDC may be connected at Charge IN+ and Charge IN− terminals of the charging unit. The AC to DC power supply is used for taking the inbound AC power from the EV charging station and rectifying it for use by the onboard charging system and battery management system it is delivering power to. The charging unit may charge the battery pack using the AC to DC power supply or be supplied with through a separate connector DC power from an external portable power supply, and therefore bypass the integrated AC to DC power supply. The charging unit further includes output terminals ‘VOUT+’ and ‘VOUT−’ for connecting a load. A positive terminal of the load is connected to the output terminal ‘VOUT+’ and a negative terminal of the load is connected to the output terminal ‘VOUT−’. The battery pack may discharge across the load and through the output terminals ‘VOUT+’ and ‘VOUT−’. The display unit may correspond to an organic light-emitting diode (OLED) display.

If the charging unit is connected to a power supply, internal or external source, discharge across the load is disabled, and there may be no output from the battery pack. At any point, if the charging unit is disconnected from a power supply, output across the load is enabled, and discharge is thus possible (assuming a Low Battery Condition is not present). During charging of the battery pack, the OLED display shows the battery pack capacity. Taking a 7-cell series configuration for a battery pack, the battery pack may be charged at a maximum 20-80 A current rating. When a battery pack of that size and number reaches 19.6 V, it is 100% charged, and further charging of the battery pack is disabled. The pack may be sized and tailored for a range in the number of cells connected in series, e.g., 3-12 cells, in each instance the unit configured to detect the number of cells connected and to calculate termination voltage for a 100% charge.

When the charging unit is not connected, the output is enabled (provided the battery pack is not drained). In some embodiments, the OLED display displays the battery pack capacity and a discharge rate. Sleep modes may be indicated during idle state, i.e., the OLED display is OFF in the event there is no discharge detected. When the battery pack dips below 14 V, the pack is in a low battery condition the discharge is disabled. The OLED display then displays a low battery indication. In some embodiments, the balancing unit monitors individual cell voltages. In the event that the voltage of any cell drops below 1.85V (regardless of other cell voltages), a low battery condition is determined, and discharge is disabled. Further, the OLED display displays the low battery indication.

The charging system enables discharge till 100 A current is achieved across the load. The discharge is disabled in the event the load consumes more than 100 A current. In that event the OLED display warns for a high current condition. To resume operation of the charging system, the OLED display provides a “Press Switch” indication. As soon as a reset switch is pressed, the charging system resumes and checks for further over discharge conditions. In such a case, the discharge is disabled again until the reset switch is pressed, or the charging system is power cycled by physically disconnecting the battery pack.

Additionally, the charging system provides protection in the event of a short circuit condition. As soon as the charging system detects the short circuit condition, the charging system disables the discharge, and the charging system goes into a halt mode. The discharge remains disabled until an on-board button is pressed to resume the operation. If the short circuit condition is not resolved, the charging system goes into the halt mode again and waits for the reset switch press. Additionally, or alternatively, the operation may be resumed after the short circuit condition is resolved by power cycling the battery pack by disconnecting the battery pack.

The balancing unit enables balancing of a pack of cells connected in series during the charging of the battery pack. As the battery pack consists of the cells connected in series, it is essential to balance individual cell so that the cells charge uniformly. For cell balancing, the battery pack is connected to the balancing unit. Specifically, a connection is tapped from each of the cells using a connector (lug) or through PCB trace. The balancing unit measures the cell voltages and maintains equal potential across the cells. The balancing unit balances the cell by bypassing the charging current and charging the individual cell with a lower current by means of sending power and dissipating a portion of that power through balancing resistors, consisting of between one and four resistors assigned to each cell for this sole purpose. These balancing resistors can also serve the purpose of dissipating excess stored energy of an individual cell if its individual terminal voltage is higher than other cells in the pack, to take place during the balancing stage of charging.

When the battery pack charging system is connected to the power supply, the balancing unit enables balancing until the battery pack reaches 100% capacity. When any of the cells in series is charged to full capacity, the balancing unit sends a command to the charging unit to disable further charging of the battery pack. But the balancing unit is still in operation and the balancing unit continues to discharge the fully charged cell to equalize it to the other cell voltage levels. Charging of the battery pack is enabled again when the voltage of each cell drops below 2.72V. The balancing operation performed by the balancing unit remains enabled until the charging unit is present and operating. In the event the charging unit is disconnected, the balancing unit ceases the balancing operation.

Applications in transportation technology are legion: The charging system can be used to charge electric bicycles, electric standing scooters, electric sit-down scooters, electric skateboards, golf carts and other vehicles in a class range of less than 10 kW of power. The system integrates with public automotive charging stations using an SAE Surface Vehicle Recommended Practice J1772, SAE Electric Vehicle Conductive Charge Coupler, or J1772 connector, also known as a J Plug.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The embodiments disclosed herein will be further explained with reference to the attached drawings, which are not scaled such that the emphasis is instead placed on the principles of operation of the presently disclosed embodiments.

FIG. 1A is a block diagram of a charging system for charging a battery pack, according to some embodiments.

FIG. 1B is a block diagram showing a connection of the battery pack with a balancing unit, via a battery terminal connector, according to some embodiments.

FIG. 1C shows an exemplary battery terminal connector, according to some embodiments.

FIG. 1D is a table showing an exemplary battery pack charging profile followed by a charging unit while charging the battery pack, according to some embodiments.

FIG. 2A shows parameters displayed by a display unit during charging of the battery pack, according to some embodiments.

FIG. 2B shows parameters displayed by the display unit during the charging of the battery pack, according to some other embodiments.

FIG. 2C shows parameters displayed by the display unit during balancing of the battery pack, according to some embodiments.

FIG. 2D shows parameters displayed by the display unit during the balancing of the battery pack, according to some other embodiments.

FIG. 3 shows a schematic of the display unit displaying different parameters during a slow charging mode, according to embodiments.

FIG. 4A shows parameters displayed by the display unit during discharging of the battery pack, according to some embodiments.

FIG. 4B shows parameters displayed by the display unit during no load detection condition, according to some embodiments.

FIG. 4C shows a notification displayed by the display unit during low battery conditions, according to some embodiments.

FIG. 4D shows a notification displayed by the display unit during over current fault condition, according to some embodiments.

FIG. 5 is a block diagram of a charging unit, according to some embodiments.

FIG. 6 is a block diagram of the balancing unit connected to the battery pack via the battery terminal connector.

FIG. 7 is a schematic block diagram showing how the inventive battery management system is incorporated in an EV charging station for micromobility vehicles.

FIG. 8 is a prior art pinout schematic wiring diagram showing an SAE J1772 connector and AVC2 configured for connection to a vehicle's onboard battery charger.

### DETAILED DESCRIPTION OF THE INVENTION

In the following description details are set forth to provide a thorough understanding of the present disclosure. It will be apparent, however, to one skilled in the art that the present disclosure may be practiced without the specificity provided in these details. In other instances, apparatuses and methods are shown in block diagram form only to facilitate the fundamental inventive concepts and principles of operation without needlessly complicating the present disclosure.

Reference in this specification to “one embodiment” or “an embodiment” means that a particular feature, structure, or characteristic described in connection with the embodiment is included in at least one embodiment of the present disclosure. The phrase “in one embodiment” in various places in the specification signifies that the feature or characteristic is not necessarily present in all embodiments, nor are separate or alternative embodiments mutually exclusive of other embodiments. Further, the terms “a” and “an” herein do not denote a limitation of quantity, but rather denote the presence of at least one of the referenced items or limitations. Moreover, various features are described that may be present in some embodiments while not in others. Similarly, various requirements are described that may be requirements for some embodiments but not for others.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

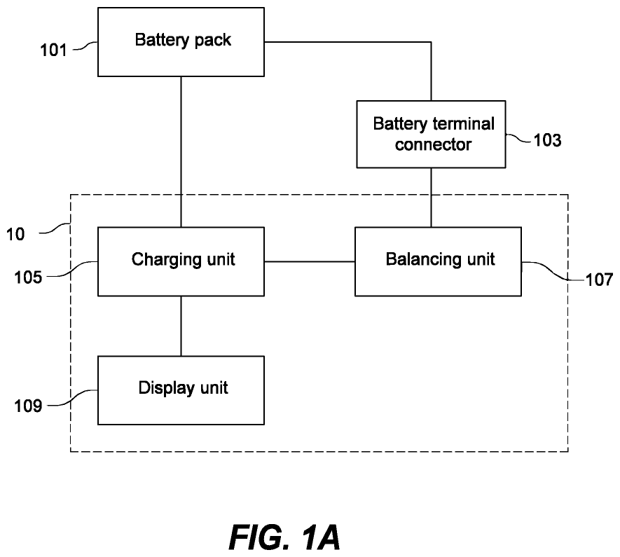

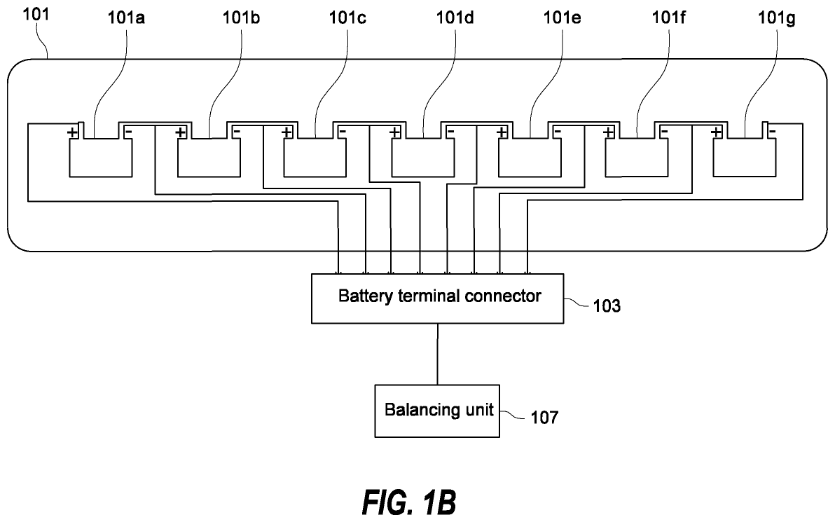

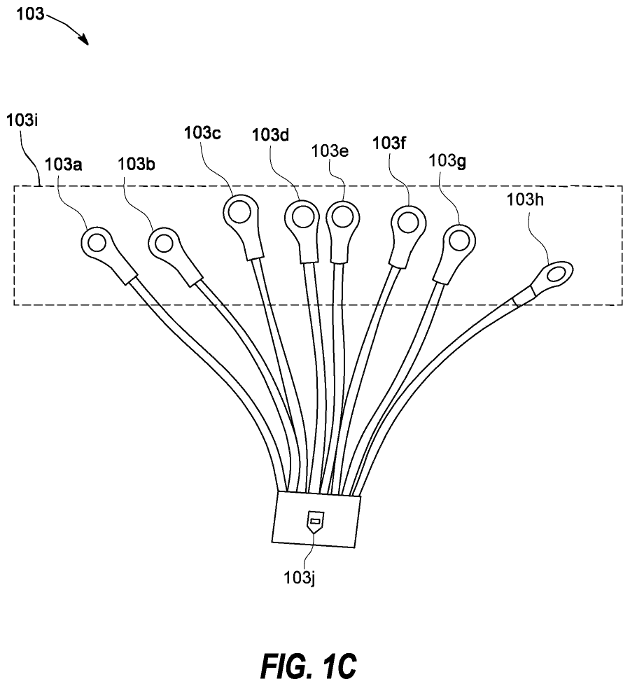

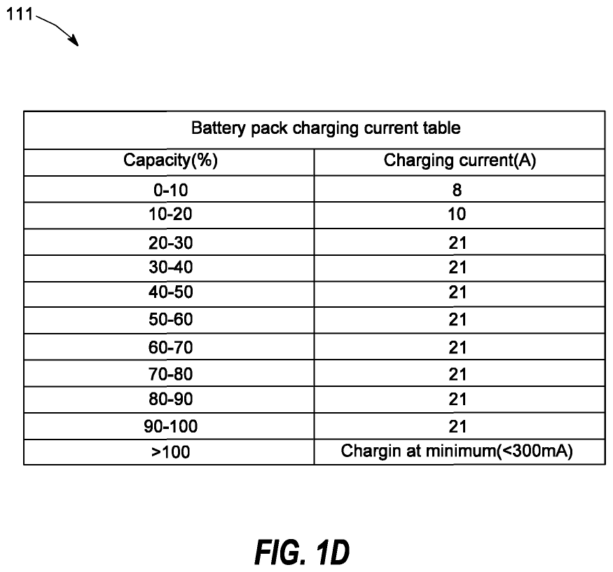

Referring now to FIG. 1A, there is shown a block diagram of a charging system 10 for charging a battery pack 101, according to some embodiments. The charging system 10 includes a charging board 100 having a charging unit 105, a balancing unit 107, and a display unit 109. The charging unit 105 is electrically connected to the balancing unit 107 and the display unit 109. In an embodiment, the charging unit 105 is electrically connected to the display unit 109 through a pigtail cable. Further, the battery pack 101 is electrically coupled to the charging unit 105. For example, a positive terminal and a negative terminal of the battery pack 101 are connected to the charging unit 105. Further, the battery pack 101 is connected to the balancing unit 107, via a battery terminal connector 103. The connection of the battery pack 101 with the balancing unit 107, via the battery terminal connector 103 is described below with reference to FIG. 1B.

FIG. 1B illustrates the connection of the battery pack 101 with the balancing unit 107, via the battery terminal connector 103, according to some embodiments. The battery pack 101 may include a plurality of rechargeable cells. For instance, the battery pack may include a plurality of lithium-titanate-oxide (LTO) cells. Here, for purposes of explanation, the battery pack 101 includes seven LTO cells 101a-101g. Each LTO cell includes a positive terminal and a negative terminal, the positive terminal denoted by ‘+’ and the negative terminal denoted by ‘-’. The LTO cells 101a-101g are connected in series. To connect each LTO cell of the LTO cells 101a-101g, which are connected in series, to the balancing unit 107, a connection needs to be tapped from each LTO cell. Such a connection can be provided by using the battery terminal connector 103.

FIG. 1C shows an exemplary battery terminal connector 103 according to some embodiments. FIG. 1A, 1B and FIG. 1C are explained collectively and in conjunction with one another. The battery terminal connector 103 includes two ends 1031 and 103j. The end 103i of the battery terminal connector 103 includes a number of lug connectors 103a-103h. The lug connector 103a is connected to the positive terminal of the LTO cell 101a, and the lug connector 103b is connected to the positive terminal of the LTO cell 101b. Likewise, the lug connectors 103c-103g are connected to the positive terminal of the LTO cells 101c-101g, respectively. The lug connector 103h is connected to the negative terminal of the LTO cell 101g. In such a manner, the end 103i of the battery terminal connector 103 is connected to the battery pack 101. Further, the end 103j of the battery terminal connector 103 is connected to the balancing unit 107. In such a way, the battery pack 101 is connected to the balancing unit 107 via the battery terminal connector 103.

Referring back now to FIG. 1A, according to an embodiment, the charging unit 105 includes terminals ‘VIN+’ and ‘VIN−’ for connecting an adapter. A positive terminal of the adapter is connected to the terminal ‘VIN+’ and a negative terminal of the adapter is connected to the terminal ‘VIN−’. In an embodiment, the adapter may be a 24V/25 A rated DC adapter. The charging unit 105 is configured to charge the battery pack 101 through the adapter. Additionally, in some embodiments, the charging unit 105 may include output terminals ‘VOUT+’ and ‘VOUT−’ for connecting a load. A positive terminal of the load is connected to the output terminal ‘VOUT+’ and a negative terminal of the load is connected to the output terminal ‘VOUT−’. The battery pack 101 may discharge across the load through the output terminals ‘VOUT+’ and ‘VOUT−’.

If the charging unit 105 is connected, then output is disabled, i.e., discharge across the load is disabled, and thus there will be no output from the battery pack 101. Further, if the charging unit 105 is disconnected, then the output is enabled, i.e., discharge across the load is enabled.

The charging unit 105 is configured to charge the battery pack 101 until capacity/charge of the battery pack 101 reaches 100%. The charging unit 105 provides a high charging current, for example 20-80 amps at up to 24 volts, which results in fast charging of the battery pack 101.

FIG. 1D shows an example battery pack charging profile 111 followed by the charging unit 103 while charging the battery pack 101, according to some embodiments. The battery pack charging profile 111 indicates that, while charging the battery pack 101 from the battery pack capacity 20%-100%, the battery pack 101 is charged at high charging current, e.g., 21 amps. Again, these values derive from an exemplary embodiment, but charging at a peak current of 80 amps is practical and fully enabled with the present invention. When the battery pack capacity reaches 100%, the charging current is reduced to charge the battery pack 101 with a minimum charging current, e.g., the charging current of magnitude less than 300 mA.

In some embodiments, the charging unit 105 is configured to charge the battery pack 101 from the battery pack capacity 8%-95% at a high charging current and from the battery pack capacity 95%-100% at a charging current of magnitude less than a magnitude of the high charging current. For example, the charging unit 105 may charge the battery pack 101 from the battery pack capacity 8%-95% at 23 A, and 95%-96% at 18 A, 96%-97% at 14 A, 97%-98% at 10 A, 98%-99% at 5 A, 99%-100% at 2 A, 100% at 0 A.

In some embodiments, during charging the charging unit 105 is configured to measure a voltage across the battery pack 101 (Vbatt) and a voltage across each LTO cell (Vcell) at regular time intervals, e.g., every 60 seconds, if the battery pack capacity is less than a threshold battery capacity (e.g., 80%) and if each LTO cell voltage is less than or equal to a threshold cell voltage (e.g., 2.72V), else the charging unit 105 measures the battery pack voltage and each LTO cell voltage every 10 seconds.

In an embodiment, the LTO cells 101a-101g of the battery pack 101 may be balanced, i.e., the LTO cells 101a-101g are at an equal potential. In some embodiments, the LTO cells 101a-101g may be imbalanced, i.e., the LTO cells 101a-101g may be at different potentials. Some embodiments are based on the principle that the charging time (i.e., time for charging the battery pack 101 to 100% battery pack capacity) depends on the imbalance between individual LTO cells. For example, if the LTO cells 101a-101g are imbalanced, the LTO cell at the highest potential may soon reach a full voltage, and to protect the LTO cell at the full voltage from over-charging, the charging current may be reduced dramatically. The reduction in the charging current leads to an increase in the time required to fully charge the remaining LTO cells, which in turn leads to an increase in the charge time of the battery pack 101. Therefore, the charging time required for charging the imbalanced LTO cells is higher than the charging time required for charging balanced LTO cells.

Some embodiments are based on the principle that the balancing unit 107 can be used to balance each LTO cell (i.e., maintain equal potential across each LTO cell of the LTO cells 101a-101g) to uniformly charge each LTO cell. Since each individual LTO cell of the set of LTO cells 101a-101g is connected to the balancing unit 107 via the lug connectors 103a-103h, the balancing unit 107 can measure the voltage across each LTO cell of the LTO cells 101a-101g. Further, the balancing unit 107 maintains equal potential across the LTO cells 101a-101g, during charging, if the LTO cells 101a-101g are imbalanced. The balancing unit 107 enables the balancing till the battery pack capacity reaches 100%.

In some embodiments, the balancing unit 107 balances the voltage across each LTO cell during charging. The voltage balancing is based on the threshold cell voltage (e.g., 2.6 V up to 2.8 V), the threshold battery pack capacity (e.g., 90-95%), and a threshold cell voltage variance (e.g., 50 mV). A cell voltage variance may be referred to as a voltage variation/difference between the LTO cells 101a-101g. The balancing unit 107 obtains a current cell voltage, a current battery capacity, and a current cell voltage variance. Further, the balancing unit 107 determines if the current cell voltage is less than the threshold cell voltage by comparing the current cell voltage to the threshold cell voltage. Furthermore, the balancing unit 107 determines if the current battery capacity and the current cell voltage variance are greater than the threshold battery capacity and the threshold cell voltage variance, respectively, by comparing the current battery capacity with the threshold battery capacity, and the current cell voltage variance with the threshold cell voltage variance.

If the current cell voltage is less than the threshold cell voltage, and if the current battery pack capacity and the current cell voltage variance are greater than the threshold battery capacity and the threshold cell voltage variance, respectively, then the balancing unit 107 balances the voltage across each LTO cell. In some embodiments, the balancing unit 107 may include a microcontroller. The microcontroller may be configured to execute the aforesaid comparison operation.

According to an embodiment, the balancing unit 107 balances the LTO cells 101a-101g by bypassing the charging current (max 1.2 A) through one or more discharge resistors, preferably embedded in the balancing board. In an embodiment, the one or more discharge resistors have ratings of 2.35 ohm, 6 W. Due to the bypassing of the charging current, the discharge resistors heat up, along with charge board electronics, and a heat sink proximate the top of the circuit board assembly may be required to liberate heat energy. To that end, in some embodiments, a heat sink is included in the charging system 100.

Further, when any of the LTO cells 101a-101g is charged to full capacity (or fully charged, or a predetermined voltage), the balancing unit 107 sends a command to the charging unit 105 to disable further charging. Subsequently, the balancing unit 105 discharges the fully charged LTO cell to equalize a voltage across the fully charged LTO cell to and a voltage across other LTO cells. Charging is enabled again when the voltage of each LTO cell drops below the threshold cell voltage. However, this describes the unique condition which is a predicate to discrete cell discharging. Typically, the balancing unit does not start discharging energy until the entire battery pack reaches a full charge, but balancing of the cells begins before the pack reaches full charge. Then once a full charge is achieved, all charging and balancing stops if all cells are at a substantially equivalent full charge state.

According to some embodiments, while balancing the LTO cells 101a-101g, the fully charged LTO cells are discharged at a discharge current, and the remaining LTO cells are charged with a charging current of magnitude greater than the magnitude of the discharge current. For example, the fully charged LTO cells are discharged at 0.3 A and the remaining LTO cells are charged with a charging current of 0.7 A.

The display unit 109 is configured to display one or more parameters indicative of a charge status of the battery pack 101. The one or more parameters may include the battery pack capacity, the charging current, the discharge current, fault indication, and the like. The display unit 109 includes an OLED display. Different parameters and notifications are displayed according to different conditions of charging of the battery pack 101. The different parameters and notifications that are displayed by the display unit 109 are described below.

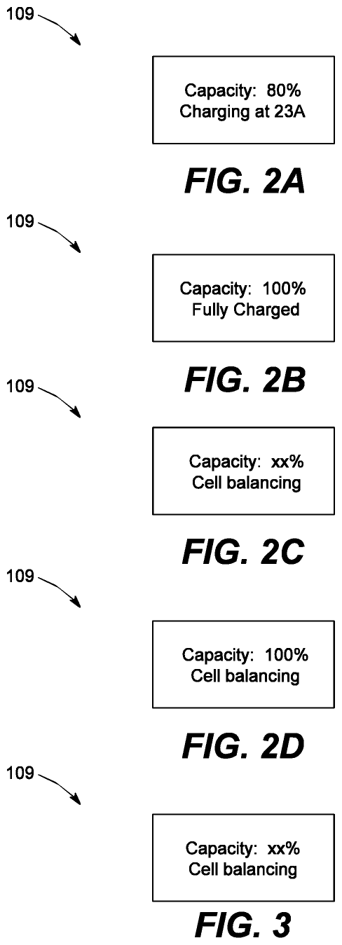

FIGS. 2A-2D collectively show different parameters displayed for different conditions by the display unit 109, during the charging and the balancing of the battery pack 101, according to some embodiments. While charging the battery pack 101, the display unit 109 displays the battery pack capacity and the charging current. For example, the display unit 109 displays “Capacity: 80% Charging at 23 A” as shown in FIG. 2A.

In some embodiments, if the battery pack capacity is 100% and each LTO cell voltage is less than or equal to the threshold cell voltage (e.g., 2.72 V), then the display unit 109 displays ‘Capacity: 100% Fully Charged’ as shown in FIG. 2B.

In an embodiment, if any LTO cell voltage is greater than the threshold cell voltage and the battery pack capacity is less than 100%, then the balancing unit 107 balances the LTO cells 101a-101g. Further, the display unit 109 displays “Capacity: xx % Cell balancing” as shown in FIG. 2C. Here “xx” represents the battery pack capacity.

In another embodiment, if any LTO cell voltage is greater than the threshold cell voltage, and if the battery pack capacity is more than 100%, then the balancing unit 107 balances the LTO cells 101a-101g and disables the charging of the battery pack 101. In such a case, the display unit 109 displays “Capacity: 100% Cell balancing” as shown in FIG. 2D.

FIG. 3 shows a schematic of the display unit 109 indicating different parameters during a slow charging mode, according to some embodiments. If the display unit 109 displays “Cell balancing” more than 10 times, then the OLED starts blinking at 8 seconds ON and 2 seconds OFF. Further, the display unit 109 displays as “Capacity: xx % Cell balancing.” According to an embodiment, the slow charging mode may be cleared by disconnecting the charging unit 105 or pressing a reset switch.

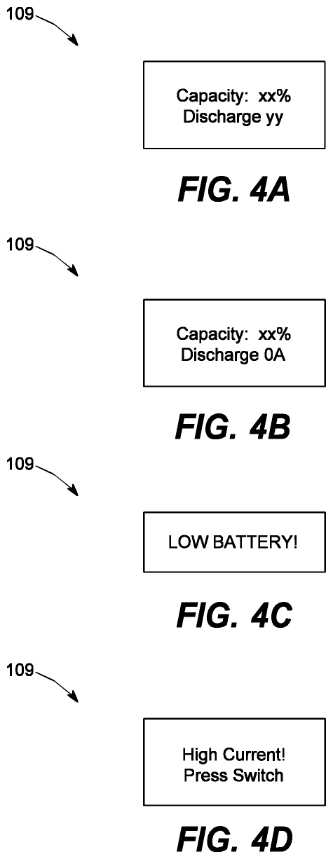

FIGS. 4A-4D collectively show different parameters displayed for different conditions by the display unit 109 during the discharging of the battery pack 101, according to some embodiments. When the charging unit 105 is disconnected, then the output is enabled for discharge across the load. If load current is greater than 0.3 A and less than 50 A, then the display unit 109 displays the battery pack capacity and the load current as “Capacity: xx % Discharge yy.” Here “xx” represents the current battery capacity and “yy” represents the discharging/load current of the battery pack 101.

In an embodiment, if the load current is less than 0.3 A, then the display unit 109 turns off, i.e., the display unit 109 transforms to an OFF state. When the reset switch is pressed, the display unit 109 turns ON for 10 seconds and displays “Capacity: xx % Discharge OA” as shown in FIG. 4B. If the load current is still less than 0.3 A, the display unit 109 turns off. In some implementations, in the event there is no discharge detected, sleep modes may be indicated when the display unit 109 is OFF.

In another embodiment, if the battery pack capacity reaches to 0%, then the output is disabled, and the OLED starts blinking at 3 seconds ON and 1 second OFF. Further, the display unit 109 displays an indication “LOW BATTERY!” as shown in FIG. 4C. In some implementations, when the battery pack voltage drops below 14V, a low battery condition is determined, and the discharge is disabled. Subsequently, the display unit 109 displays a low battery indication as shown in FIG. 4C. In other implementations, if the voltage of any LTO cell drops below the threshold cell voltage (regardless of other LTO cells voltages), a low battery condition is determined, and the discharge is disabled. Subsequently, the display unit 109 displays the low battery indication as shown in FIG. 4C.

In some other embodiments, if the load current is more than 50 A or 100 A, then the output is disabled, and the OLED starts blinking at 3 seconds ON and 1 second OFF. Further, the display unit 109 displays “High Current! Press Switch” as shown in FIG. 4D. Such a condition corresponds to an over current fault condition. According to an embodiment, the over current fault condition may be cleared by reconnecting the charging unit 105 or pressing the reset switch press. As soon as the reset switch is pressed, the charging system 10 resumes and checks for further over current fault conditions.

Additionally, in some embodiments, the charging system 10 provides protection in the event of a short circuit condition. The charging system 10 is configured to detect the short circuit condition. In response to the detection of the short circuit condition, the charging system 10 disables the discharge and switches into a halt mode. The discharge remains disabled until the reset switch is pressed to resume operation of the charging system. If the short circuit condition is not resolved, the charging system 10 goes into the halt mode again and waits for the reset switch press. Additionally, or alternatively, in some embodiments, after the short circuit condition detection, the operation of the charging system 10 may be resumed by power cycling the battery pack 101 by disconnecting the battery pack 101. To that end, the charging system 10 provides protection against the fault conditions such as the over current fault condition and the short circuit condition.

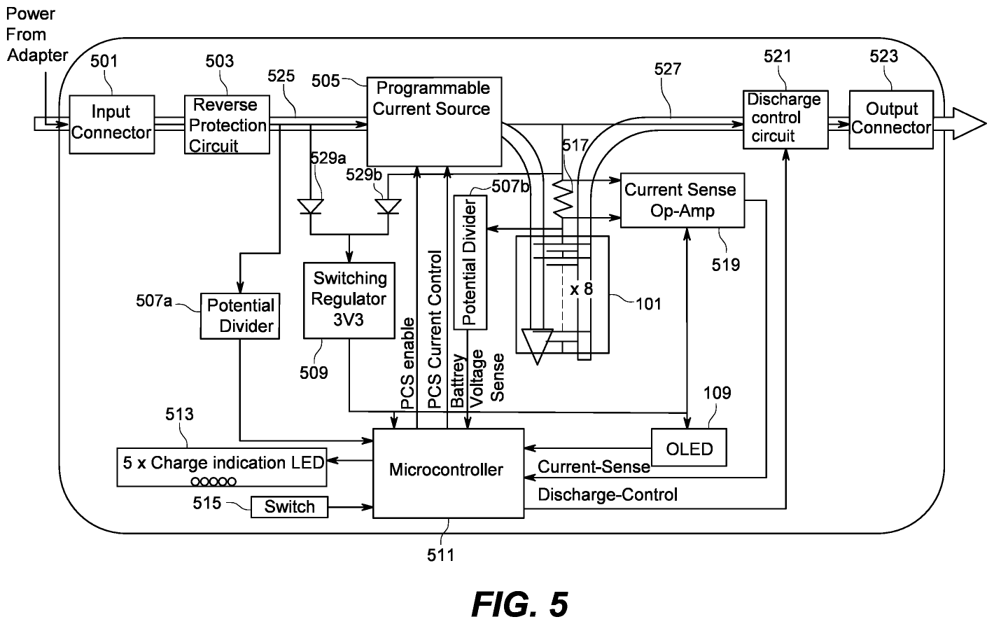

FIG. 5 is a block diagram of the charging unit 105, according to some embodiments. The charging unit 105 includes an input connector 501, a reverse protection circuit 503, a Programmable Current Source (PCS) 505, potential dividers 507a and 507b, a switching regulator 3V3 509, a microcontroller 511, a 5× charge indication LED 513, a switch 515, a current sense resistor 517, a current sense Op Amp 519, a discharge control circuit 521, and an output connector 523. Here, the battery pack 101 and the display unit 109 (OLED) are incorporated in the charging unit 105. Arrow 525 represents current flow during charging of the battery pack 101. Arrow 527 represents current flow during battery pack discharging.

The input connector 501 is a receptacle for connecting an external voltage source with which to charge the battery pack 101. In an embodiment, input connector 501 may be shared with the output connector 523. The reverse protection circuit 503 is configured to prevent current from flowing out of the programmable current source 505 back through the input connector 501. The reverse protection circuit 503 may be implemented using a metal-oxide-semiconductor field-effect transistor (MOSFET) or a diode.

The programmable current source 505 is configured to control the current and voltage delivered to the battery pack 101. An external control circuit can be used to enable or disable the programmable current source 505. Additionally, or alternatively, in some embodiments, an external control circuit can be used to control the current and voltage from the programmable current source 505 to the battery pack 101.

The potential divider 507a may act as a voltage attenuator to reduce voltage from the input connector 501 to a level acceptable for input to one or more analog-to-digital converter(s) (ADCs) located in the microcontroller 511. The potential divider 507b acts as a voltage attenuator to reduce voltage from the battery pack 101 to a level acceptable for the input to the ADC(s) located in the microcontroller 511. Alternatively, in some embodiments, a single potential divider may be multiplexed between multiple voltage sources, rather than using separate potential dividers for each voltage source. The potential dividers 507a and 507b may be implemented using one or more ADCs, either internal or external to the microcontroller 511.

Switching regulator 3V3 509 is a voltage regulator configured to provide a required regulated voltage to power electronics internal to the battery pack 101. An input source to the switching regulator 3V3 509 may be either the external voltage source or the battery pack 101. The switching regulator 3V3 509 may either be of a linear or a switching topology. Further, diodes 529a and 529b may be used to automatically select the input source for the switching regulator 3V3 509.

Microcontroller 511 is configured to control circuits in the battery pack 101 and communicate with external devices. In an embodiment, microcontroller 511 may be a collection of circuits that perform desired functions. Microcontroller 511 includes the analog-to-digital converter(s) (ADCs) configured to convert monitored voltages to digital data. Microcontroller 511 may require an input voltage to provide power to operate the circuits in the battery pack 101, and general purpose input and output (GPIO) signals to control the circuits in the battery pack 101. Further, microcontroller 511 may provide one or more control signals to the reverse protection circuit 503 and the discharge control circuit 521.

The 5× charge indication LED 513 is configured to indicate a charge status of the battery pack 101. The 5× charge indication LED 513 may be implemented in a series of LEDs. In some embodiments, the 5× charge indication LED 513 can be expressed in audible tones.

Switch 515 is a mechanical or electronic switch configured to enable and disable circuits associated with the battery pack 101. It may also put the battery pack electronics in additional configurations, such as low power sleep mode.

The current sense resistor 517 is a current monitoring element placed in series with the battery pack 101 to monitor current flowing into and out of the battery pack 101. The current sense Op Amp 519 is an electronic circuit configured to monitor an output voltage or a current associated with the current sense resistor 517. In particular, the current sense Op Amp 519 conditions an output signal from the current sense resistor 517 to provide a correct signal for use by the microcontroller 511.

The discharge control circuit 521 is configured to prevent current from flowing into the programmable current source 505 from the output connector 523. The discharge control circuit 521 may be implemented using a MOSFET or a diode. The output connector 523 is a receptacle for connecting the battery pack to an external load. In an embodiment, the output connector 523 may be shared with the input connector 501.

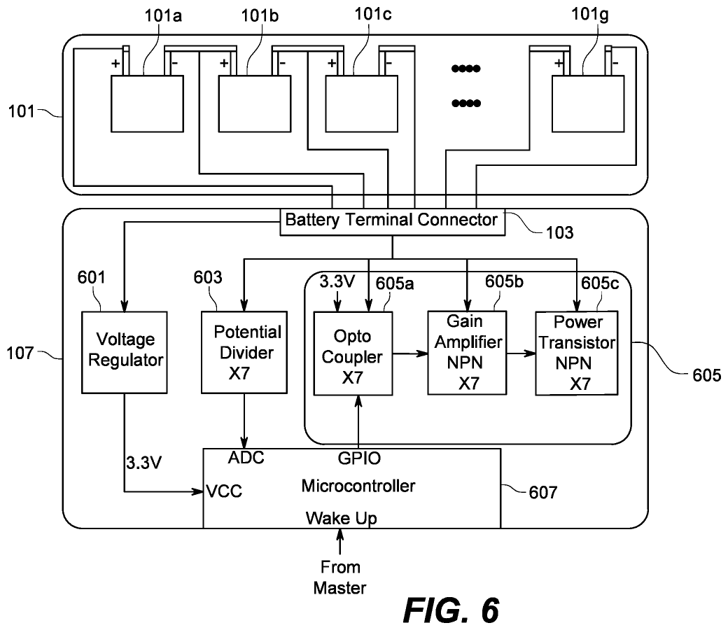

FIG. 6 is a block diagram showing the balancing unit 107 connected to the battery pack 101 via the battery terminal connector 103. Here, the battery terminal connector 103 is shown as an internal component of the balancing unit 107. The battery pack 101 is a source of operating power for the balancing unit 107, which includes a voltage regulator 601, a potential divider 603, a cell balancing circuit 605, and a microcontroller 607.

The voltage regulator 601 converts the voltage from the battery pack 101 to a level required by circuits in the balancing unit 107. An input voltage range to the voltage regulator 601 may be based on chemistry of the cells 101a-101g and the number of cells in the battery pack 101. An output voltage of the voltage regulator 601 is defined by voltage(s) required to operate the circuits in the balancing unit 107. For instance, the voltage regulator 601 provides an output voltage of 3.3V to the microcontroller 607 and an optocoupler 605a.

The potential divider 603 includes one or more voltage attenuators to reduce a voltage range from each cell in the battery pack 101 to a range acceptable for input to an analog-to-digital converter (ADC) located in the microcontroller 607. One voltage attenuator may be required for each cell in the battery pack 101. In an embodiment, the potential divider 603 may be implemented using one or more ADCs (either internal or external to the microcontroller 607) with an adequate input voltage differential mode range to obviate the need for voltage attenuators. In another embodiment, the potential divider 603 may be implemented using one or more ADCs (either internal or external to the microcontroller 607) with an adequate input voltage common mode range to measure each cell individually and also obviate the need for voltage attenuators.

The cell balancing circuit 605 includes at least one optocoupler 605a, at least one gain amplifier 605b, and at least one power transistor 605c. The cell balancing circuit 605 ensures that a state of charge of each cell in the battery pack 101 is substantially equal to achieve maximum battery pack operating life. The states of charge of each cell are equalized by drawing charge from cells having more charge. The charge drawn from the more charged cells can either be dissipated as heat, or used, for example, to increase the charge in other cells in the battery pack 101. In some embodiments, a single cell balancing discharge circuit can be multiplexed between the cells 101a-101g in the battery pack 101, or the cell balancing circuit 605 can be constructed for each cell in the battery pack 101.

The microcontroller 607 is configured to control balancing of the cells 101a-101g in the battery pack 101 and to communicate with external devices. In an embodiment, microcontroller 607 may be a collection of circuits to perform the desired functions. Microcontroller 607 includes analog-to-digital converter(s) (ADCs) configured to convert the cell voltages to digital data. Microcontroller 607 may require an input voltage to provide power for operating the cell balancing circuit 605, and general purpose input and output (GPIO) signals to control the cell balancing circuit 605.

According to an embodiment, the charging system 10 provides integrated high charging current and balancing for the battery pack 101 including the plurality of rechargeable cells. Thereby, the charging system 10 charges the battery pack 101 in an efficient manner. Further, the charging system 10 provides the charging current between 20-80 Amps at up to 24 volts to allow fast charging of the battery pack 101. The charging system 10 can be integrated with any energy storage device (such as batteries) in the range of 100-1000 Wh of storage. It will be appreciated, moreover, that the charging system described herein is configured specifically for LTO cells, but setpoints (such as individual cell voltage ranges) could be adjusted for implementation with other battery types without departing from the spirit and the scope of the present invention. The principal modifications for the adaptations be in firmware and software, not system hardware.

The charging system 10 can be used in electric bicycles, electric scooters, electric skateboards and other mobility vehicles in a class range of less than 10 kW of power. Indeed, the inventive system can be used for energy recycling, inasmuch as regenerative energy for the charging system can be derived from either potential or kinetic sources, for instance from exercise equipment such as stationary bicycles, rowing machines, stair climbers, elliptical trainers, vertical climbers, cross-country ski machines, and the like.

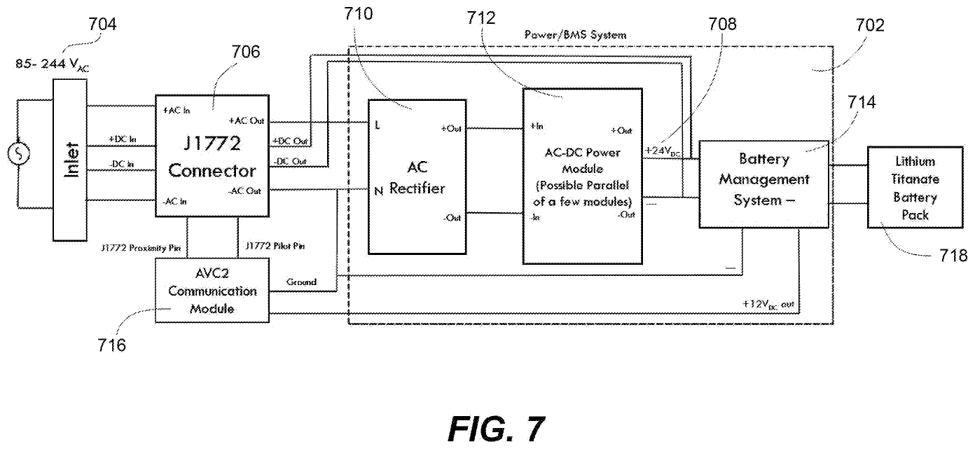

Referring now to FIG. 7, there is shown in a block diagrammatic schematic view the above-described battery management system implemented in an electric vehicle charging system 700. The system uses a maximum input current of ˜100 amps @24-54 volts DC and has an input power of approx. 1,400-5,400 watts. Its discharge current safety cutoff is 150 Amps and has a regenerative current limit input of 150 Amps. The system improves the charge curve with the fastest constant current/constant voltage (CC/CV) input possible. With a maximum charge percentage of 95% before balancing input, the balancing curve is optimized according to the battery cell chemistry.

When the system is configured for charging an electric vehicle through the power/battery management system 702, AC Power output 704 from a public charging station or residential or business power supply (@ 85 to 244 VAC) is accessed via an SAE J1772 connector (J-Plug) 706 (or and converted to 24 VDC Power 708 by an AC rectifier 710 connected to at least one AD-DC power module 712 and delivered to the BMS 714. If more than one AC-DC power module is employed, they may be connected in parallel.

The system communicates with an active vehicle side control board module 716, such as the AVC2 by Electric Motorsport, Inc., of San Leandro, Calif. Thus, the system can accommodate either AC Level 1 charging at 120 VAC or Level 2 charging at 240 VAC. Power levels for AC level charging systems range between a 1.4 kW minimum and a 19.2 kW maximum. The input power is provided to the AC-DC converter and battery management system (BMS) for charging the LTO battery pack 718. Integrating the AC-DC power system with the BMS also enables the systems to charge from any EV charging station, delivering charging power to an LTO battery pack.

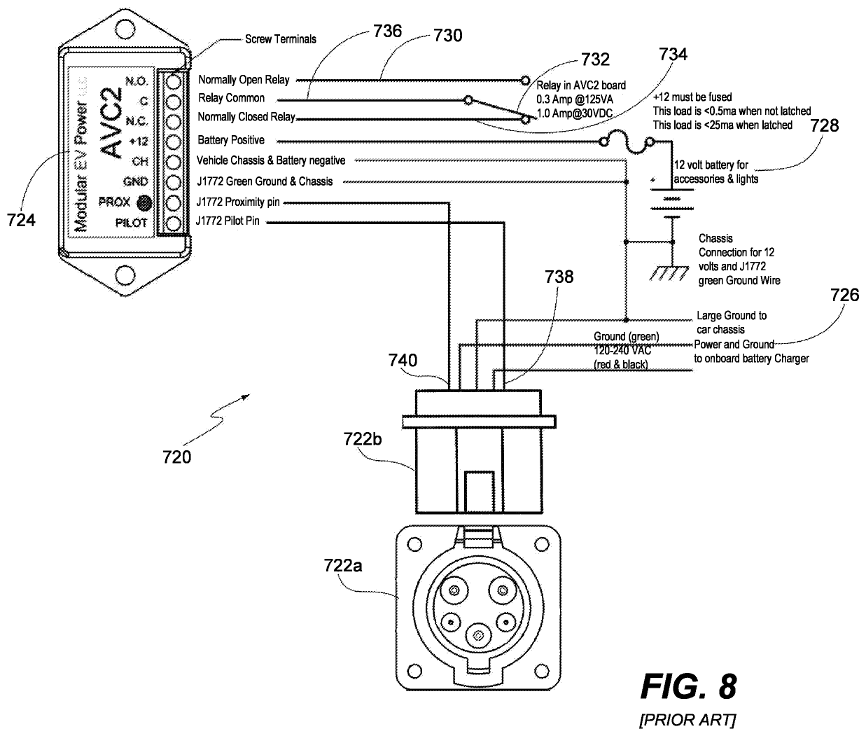

System Operation: Looking next at FIG. 8, there is shown a prior art pinout schematic wiring diagram 720 illustrating how an SAE J1772, including a plug/connector 722a and an inlet/socket 722b, may be coupled with an active vehicle control module 724 and configured for connection to a vehicle's onboard battery charger 726. In operation, the user's onboard vehicle battery provides and applies+12V DC power 728. The unit may use power from any fused source and it may be switched to enable the charging process or power may be left on continuously.

When the J1772 connector is not mated with the inlet, the Normally Open Relay 730 on the J1772/AVC2 board 724 remains in the default open position, and the contact 732 of the NC (Normally Closed) relay 734 is connected to the relay common 736. When the J1772 connector is plugged into the inlet, the pilot signal from the pilot pin 738 immediately changes to “Connected.” However, no power for charging will be provided until the latch on the J1772 connector locks on the inlet and the trigger is released; then the AVC board uses the proximity signal from the proximity pin 740 and activates the relay connecting common to Normally Open. A green PROX LED (proximity or latch) provides the indication to the user. The pilot signal from the pilot pin 738 changes to request power from the electric vehicle supply equipment (EVSE).

When it is time to disconnect, pressing the J-Plug trigger to release the connector latch is sensed by the AVC board. The relay turns off, the connector returns to common to Normally Closed, the green PROX LED goes off, and the pilot signal is changed back to CONNECTED and stops charging power. This is completed before the connectors are separated.

The foregoing description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Many modifications and other embodiments of the inventions set forth herein will occur to one skilled in the art to which the invention pertains, but only in virtue of having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed as invention is:

1. An electric vehicle charging system for micromobility vehicles, comprising a power/battery management system configured to be electrically connected to, and interposed between, a plurality of rechargeable cells in a lithium-ion or lithium titanate battery pack and an electrical connector for electric vehicles connected to an active vehicle side control board module, said battery management system (BMS) including a charging unit, a balancing unit electrically coupled to said charging unit and configured to balance voltage across each rechargeable cell of the plurality of rechargeable cells, and a display unit electrically coupled to said charging unit and configured to display at least one parameter indicative of a charge status of the battery pack, said power/battery management system further including an AC-DC power converter to convert AC power to DC power for delivery to said BMS.

2. The electric vehicle charging system of claim 1, wherein said balancing unit is further configured to balance the voltage across each rechargeable cell of the plurality of rechargeable cells during charging of the battery pack, based on a threshold cell voltage, a threshold battery capacity, and a threshold cell voltage variance.

3. The electric vehicle charging system of claim 2, wherein to balance the voltage across each rechargeable cell of the plurality of rechargeable cells during the charging of the battery pack, the balancing unit is further configured to:
obtain a current cell voltage, a current battery capacity, and a current cell voltage variance;
determine if the current cell voltage is less than the threshold cell voltage;
determine if the current battery capacity and the current cell voltage variance are greater than the threshold battery capacity and the threshold cell voltage variance; and
balance the voltage across each rechargeable cell of the plurality of rechargeable cells, based on determination that: the current cell voltage is less than the threshold cell voltage, the current battery capacity is greater than the threshold battery capacity and the current cell voltage variance is greater than the threshold cell voltage variance.

4. The electric vehicle charging system of claim 3, wherein the balancing unit is further configured to balance the voltage across each rechargeable cell of the plurality of rechargeable cells by bypassing a charging current through one or more discharge resistors.

5. The electric vehicle charging system of claim 1, wherein the balancing unit is further configured to transmit a command to the charging unit to disable charging of the battery pack, when at least one rechargeable cell of the plurality of rechargeable cells is charged to full capacity.

6. The electric vehicle charging system of claim 1, wherein the charging unit is further configured to measure, at regular time intervals, a voltage across the battery pack and a voltage across each rechargeable cell of the plurality of rechargeable cells.

7. The electric vehicle charging system of claim 1, wherein the battery pack is electrically coupled to the balancing unit via a battery terminal connector.

8. The electric vehicle charging system of claim 7, wherein the battery terminal connector includes a plurality of lug connectors.

9. The electric vehicle charging system of claim 8, wherein the plurality of rechargeable cells is connected in a series configuration and each rechargeable cell of the plurality of rechargeable cells connected in the series configuration is connected to the balancing unit using the plurality of lug connectors.

10. The electric vehicle charging system of claim 1, wherein the display unit is electrically coupled to the charging unit via a pigtail cable.

11. The electric vehicle charging system of claim 1, wherein the display unit includes an Organic Light-Emitting Diode (OLED) display.

12. The electric vehicle charging system of claim 1, wherein the at least one parameter indicative of the charge status of the battery pack includes a battery pack capacity, a charging current, a discharge current, and a fault notification.

13. The electric vehicle charging system of claim 1, further comprising a heat sink configured to liberate heat energy generated by one or more power electronics components on the charging board.

14. The electric vehicle charging system of claim 1, wherein during the charging of the battery pack, discharge of the battery pack across a load is disabled.

15. The electric vehicle charging system of claim 14, wherein the discharge of the battery pack across the load is enabled in case of disconnection of the charging unit.

16. The electric vehicle charging system of claim 1, wherein said electrical connector for electric vehicles is an SAE J1772 electric vehicle conductive charge coupler.

17. The electric vehicle charging system of claim 16, wherein said active vehicle control side board is an ACV2.

18. The electric vehicle charging system of claim 1, wherein said active vehicle control side board is an ACV2.

19. The electric vehicle charging system of claim 1, wherein said AC-DC power converter comprises an AC rectifier connected to at least one AD-DC power module.

20. The electric vehicle charging system of claim 19, wherein said AC-DC converter includes a plurality of AC-DC power modules connected in parallel.
